(19) United States
(12) Patent Application Publication
(10) Pub. No.: US 2006/0136710 A1
(43) Pub. Date: Jun. 22, 2006

(54) Allowing or disallowing firmware upgrade based on comparison of firmware-related bits

(76) Inventors: Kenji Oka, Kanagawa-ken (JP); Eitaroh Kasamatsu, Kawasaki-shi (JP); Shinji Ohishi, Yamato-shi (JP)

Correspondence Address: LAW OFFICES OF MICHAEL DRYJA, 704 228TH AVENUE NE, PMB 694, SAMMAMISH, WA, 98074, US

(21) Appl. No.: 11/020,595

(22) Filed: Dec. 22, 2004

(51) Int. Cl. G06F 1/24

(52) U.S. Cl. 713/100

(57) ABSTRACT

A first series of bits corresponds to compatibility information of firmware of a computer system. Each bit corresponds to an attribute of the firmware or the system, is equal to one when the attribute denotes a potential incompatibility factor as to the attribute, and is otherwise equal to zero. A second series of bits corresponds to a firmware image with which the firmware is to be upgraded. Each bit indicates whether the firmware image is compatible with the attribute of a corresponding first series bit, is equal to one where the firmware image is compatible with the attribute, and is otherwise equal to zero. A logical AND operation is performed on the first and the second series of bits. Where the result of the logical AND operation is equal to the first series of bits, the firmware is allowed to be upgraded with the image, and otherwise is disallowed.

### FIELD OF THE INVENTION

The present invention relates generally to upgrading the firmware of a computer system with a new firmware image, and more particularly to determining whether to allow or disallow the upgrade based on comparing firmware-related bits of the firmware of the computer system with corresponding bits associated with the new firmware image.

### BACKGROUND OF THE INVENTION

The firmware of a computer system can be considered a category of computer program code and data that is stored on non-volatile memories that hold their content without electrical power. Such non-volatile memories include read-only memories (ROM's), programmable ROM's (PROM's), electrically programmable ROM's (EPROM's), and electrically erasable and programmable ROM's (EEPROM's). Firmware is thus “hard software” when storing computer program code.

One common type of firmware is known as the basic input/output system (BIOS) of a computer. The BIOS may be considered an essential set of computer program routines, which are stored in a non-volatile memory and provide an interface between the operating system and the hardware. The BIOS supports peripheral technologies and internal services such as a realtime time-and-date clock.

The firmware of a computer system may have to be periodically updated, or upgraded, to keep pace with new peripheral technologies, or to correct bugs present in the current firmware. If the firmware is stored on a ROM, it has to be physically replaced. However, if the firmware is stored on an EPROM or an EEPROM, it can be upgraded via software, by a new firmware image being loaded into the EPROM or EEPROM.

Desirably, firmware is common across a number of different types of computer systems, for a variety of reasons. First, having a common firmware decreases costs borne on users, especially information technology (IT) administrators, who otherwise have to manage separate firmware for different types of computer systems. Furthermore, having a common firmware decreases the number of firmware download pages on web sites throughout the world. Having a common firmware for a number of different types of computer systems also decreases the number of different items that have to be managed in factories, and that have to be addressed during development and test processes.

However, invariably a new firmware image may not be compatible with one or more specific types of computer systems. In such instances, there are a variety of strategies for handling firmware upgrades. First, two or more different versions of a new firmware image may be provided. However, this strategy increases costs, for the reasons described in the previous paragraph.

Second, a “read me” or other type of file may be provided with a firmware update package, or another type of change history file may be provided. Therefore, users are able to determine whether a given new firmware image is compatible with their different computer systems. However, this approach places an undue burden on users, and cannot prevent users from accidentally installing the incorrect firmware image for a given computer system.

Third, a system identifier, or ID, may be utilized. If the system identifier of a computer system does not match one of the system identifiers stored in the new firmware image, then the computer system is prevented from having its firmware upgraded with this new firmware image. When a new type of computer system is introduced, changes are made so that the new type of computer system returns a different system identifier than the old type of computer system. The system identifiers of all the possible different computer systems with which a given firmware image is compatible have to be added to the firmware image.

Furthermore, the firmware update program that is used to update the firmware of a system itself has to be updated to ensure that it is compatible with the new type of computer system, and moreover that it properly obtains the system identifier from the new type of computer system, and properly compares this identifier with identifiers stored in the new firmware image. That is, this strategy requires that the firmware update program itself be updated each time a new type of computer system is introduced. The strategy also requires that the firmware update program itself be updated each time a new firmware image is introduced.

Therefore, this approach is inflexible. It requires that changes be made to both the firmware and the firmware update program when a new type of computer system is introduced, so that the firmware of a new type of computer system has a unique identifier, and so that the firmware update program is aware of all different types of computer systems that may potentially be affected by a new firmware image. As such, the firmware upgrade program must be effectively synchronized with a given firmware image that is introduced. The same firmware upgrade program cannot be used for all different types of computer systems, nor for all new firmware images introduced.

For these and other reasons, therefore, there is a need for the present invention.

### SUMMARY OF THE INVENTION

The present invention relates to allowing or disallowing firmware upgrades based on comparisons of firmware-related bits. A method of the invention determines a first series of firmware-related bits. The first series of bits corresponds to firmware compatibility information of firmware of a computer system. Each bit of the first series corresponds in particular corresponds to an attribute of either the firmware or the computer system. Each bit of the first series may be equal to one when the attribute to which the bit corresponds denotes a potential incompatibility factor of the computer system as to the attribute, and may otherwise be equal to zero.

The method determines a second series of firmware-related bits. The second series of bits corresponds to a firmware image with which the firmware of the computer system is desired to be upgraded. Each bit of the second series indicates whether the firmware image is compatible with the attribute of a corresponding bit of the first series. Each bit of the second series may be equal to one where the firmware image is compatible with the attribute of the corresponding bit of the first series, such that the firmware image does not cause the potential incompatibility factor of the computer system denoted by the corresponding bit of the first series. Each bit of the second series may otherwise be equal to zero.

The method performs a logical AND operation on the first series of bits and the second series of bits. Where the result of the logical AND operation is equal to the first series of bits, the firmware of the computer system is allowed to be upgraded with the firmware image. However, where the result of the logical AND operation is not equal to the first series of bits, the firmware of the computer system is disallowed from being upgraded with the firmware image. In this way, the firmware of the computer system can be upgraded with the firmware image only if the firmware image is compatible with the computer system.

A computer system of the invention includes a firmware that has an associated first series of bits corresponding to compatibility information of the firmware. Each bit of the first series corresponds to an attribute of the computer system or the firmware. The computer system also includes a storage device that is able to store a computer program executed by the computer system to upgrade the firmware based on at least the first series of bits associated with the firmware.

The computer program is specifically to upgrade the firmware of the computer system with a firmware image having an associated second series of bits. Each bit of the second series indicates whether the firmware image is compatible with the attribute of a corresponding bit of the first series. The computer program is to upgrade the firmware of the computer system with the firmware image based on the first series of bits associated with the firmware and the second series of bits associated with the firmware image.

For example, the computer program can perform a logical AND operation on the first series of bits and the second series of bits. Where the result of the logical AND operation is equal to the first series of bits, the computer program upgrades the firmware with the firmware image. Where the result of the logical AND operation is not equal to the first series of bits, the computer program does not upgrade the firmware with the firmware image.

An article of manufacture of the invention includes a computer-readable medium and means in the medium. The computer-readable medium may be a recordable data storage medium, a modulated carrier signal, or another type of computer-readable medium. The means is for upgrading the firmware of a computer system with a firmware image, based on comparing a first series of bits associated with the firmware with a second series of bits associated with the firmware image. Each first series bit corresponds to an attribute of the computer system or the firmware. Each second series bit indicates whether the firmware image is compatible with the attribute of a corresponding first series bit.

Embodiments of the invention provide for advantages over the prior art. Each bit is independent of the other bits. There are a sufficient number of bits in each of the first series and the second series of bits to reflect all current and potentially future incompatibility factors that may need to be taken into account during the firmware upgrade process. The first series of bits is resident in the firmware of the computer system, whereas the second series of bits is resident in a new firmware image. The firmware upgrade computer program does not have to be aware of the details or the origin of the first and the second series of bits. Thus, the same firmware upgrade program can be used to administer firmware upgrades on any type of computer system on which the program is able to be run, for any new firmware image. That is, updates of the firmware upgrade program do not have to be synchronized with new firmware images. The comparison performed by the firmware upgrade program is always the same, and different comparisons do not have to be addressed by the firmware upgrade program when new types of computer systems are introduced.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a scenario for upgrading the firmware of a computer system with a new firmware image, according to an embodiment of the invention.

FIG. 2 is a diagram of how the first series of bits of a computer system are compared with the second series of bits of a new firmware image to determine whether the firmware image is to be loaded into the firmware of the computer system, according to an embodiment of the invention.

FIG. 3 is a flowchart of a method for determining whether to allow the firmware of a computer system to be upgraded with a new firmware image, according to an embodiment of the invention.

FIG. 4 is a diagram of a rudimentary computer system, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

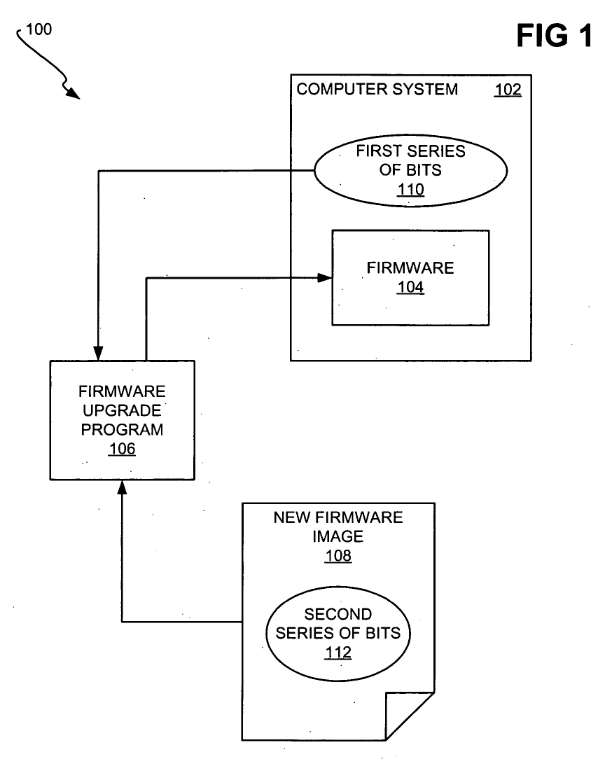

FIG. 1 shows a scenario 100 by which the firmware 104 of a computer system 102 is upgraded by a firmware upgrade computer program 106 with a new firmware image 108, according to an embodiment of the invention. The computer system 102 can include any type of computing device or peripheral that has a firmware. For instance, the computer system 102 may be a desktop or a laptop computer, as well as peripherals such as video cards, sound cards, and so on. The firmware 104 may be a basic input/output system (BIOS), or another type of firmware, as has been described in the background section. The firmware 104 is stored in a non-volatile memory of the computer system 102, such as a non-volatile memory integrated circuit (IC).

The firmware upgrade program 106 is a computer program designed to upgrade the firmware 104 with the new firmware image 108, and can run on the computer system 102. The upgrade program 108 is preferably not dependent on the specific firmware image 108 with which the firmware 104 is being upgraded. Furthermore, the upgrade program 108 is preferably not dependent on the specific firmware 104, nor on the specific computer system 102. That is, so long as the computer system 102 is able to run or execute the firmware upgrade computer program 106, the program 106 does not have to take into account specific details of the firmware image 108 or the firmware 104.

The firmware image 108 may be a binary or other type of data file that is designed to be loaded into the firmware 104 to update the firmware 104. For instance, the firmware image 108 may enable the computer system 102 to take advantage of new features coded into the firmware image 108 that are not present already in the firmware 104. The firmware image 108 may enable the system 102 to also take advantage of new peripheral technologies that are not afforded by the firmware 104. The firmware image 108 may also contain bug fixes and other corrections to the firmware 104.

The computer system 102 has an associated first series of firmware-related bits 110, and the firmware image 108 has an associated second series of firmware-related bits 112. The first series of bits 110 corresponds to firmware compatibility information of the firmware 104 of the computer system 104, as is described in more detail later in the detailed description. The second series of bits 112 corresponds to the firmware image 108 with which the firmware 104 of the computer system 102 is to be upgraded, as is described in more detail later in the detailed description.

The first series of bits 110 is stored within the computer system 102, such as within the firmware 104 thereof. For instance, the first series of bits 110 may be stored in the BIOS location 15h, may be obtained via a software system management interrupt (SMI), and/or may be stored in a table within a BIOS read-only memory (ROM) area, as can be appreciated by those of ordinary skill within the art. The second series of bits 112 may be stored within the new firmware image 108 itself, such as within the same binary or other data file encompassing the firmware image 108.

The firmware upgrade computer program 106 first verifies that the firmware image 108 is compatible with the computer system 102 before upgrading the firmware 104 with the new image 108. This is preferably accomplished as follows. First, the program 106 determines, or receives, the first series of bits 110 from the computer system 102. Next, the program 106 determines, or receives, the second series of bits 112 from the firmware image 108. The program 106 performs a logical AND operation on the first series of bits 110 with the second series of bits 112.

If the result of the logical AND operation is equal to the first series of bits 110, then the program 106 upgrades the firmware 104 with the firmware image 108. That is, the upgrade program 106 loads the firmware image 108 into the firmware 104, as is known within the art. If the result of the logical AND operation is not equal to the first series of bits 110, then the program 106 concludes that the firmware image 108 is not compatible with the computer system 102, and does not upgrade the firmware 104 with the firmware image 108.

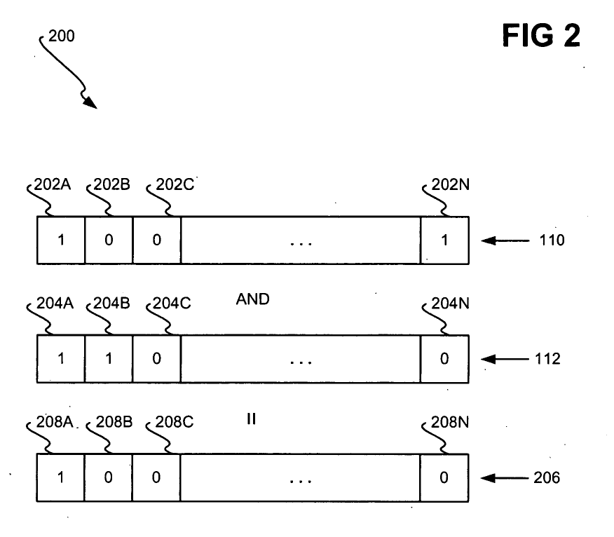

FIG. 2 shows a scenario 200 depicting in more detail how the process by which the first series of firmware-related bits 110 is compared with the second series of firmware-related bits 112 to determine whether to upgrade the firmware 104 of FIG. 1 with the firmware image 108 of FIG. 1, according to an embodiment of the invention. The first series of bits 110 includes the bits 202A, 202B, 202C, . . . , 202N, collectively referred to as the bits 202. The second series of bits 112 includes the bits 204A, 204B, 204C, . . . , 204N, collectively referred to as the bits 204. Performing a logical AND operation on the first series of bits 110 and the second series of bits 112 results in the series of bits 206. The series of bits 206 includes the bits 208A, 208B, . . . , 208N, collectively referred to as the bits 208. It is noted that each of the series of bits 110, 112, and 206 can be represented by a decimal or a hexadecimal value, where this value is expressed in binary form as depicted in FIG. 2.

Each of the bits 202 of the first series of bits 110 corresponds to an attribute of the computer system 102 or of the firmware 104. In particular, each of the bits 202 is equal to a value of one where the attribute to which this bit corresponds denotes a potential incompatibility factor of the computer system 102 as to this attribute. Each of the bits 202 is otherwise equal to a value of zero, indicating that the attribute to which this bit corresponds does not denote a potential incompatibility factor of the computer system 102 as to this attribute.

For example, the bit 202A may indicate whether the computer system 102 has a particular type of graphics chip A. Because the bit 202A is specifically equal to the value of one, this means that the computer system 102 has this particular type of graphics chip A. Thus, the bit 202A denotes a potential incompatibility factor of the computer system 102 as to this attribute, because if a given firmware image, such as the image 108, is not compatible with this particular type of graphics chip A, then the firmware 104 of the computer system 102 should not be upgraded with that firmware image.

Conversely, the bit 202B may indicate whether the computer system 102 has a particular type of graphics chip B, whereas the bit 202C may indicate whether the computer system 102 has a particular type of graphics chip C. Because the bits 202B and 202C are each specifically equal to the value of zero, this means that the computer system 102 does not have either the particular type of graphics chip B or the particular type of graphics chip C. Thus, the bits 202B and 202C do not denote potential incompatibility factors of the computer system 102 as to these attributes, because even where a given firmware image is not compatible with the particular types of graphics chips B and C, this incompatibility does not affect the ability of the computer system 102 to have its firmware 104 upgraded with the firmware image. That is, because the computer system 102 does not have the particular type of graphics chip B or C, it does not matter whether a new firmware image is compatible with these types of graphics chips or not.

As a further example, the bit 202N may indicate whether the computer system 102 and/or the firmware 104 is able to support encrypted password protection within the firmware 104. In one embodiment, because the bit 202N is specifically equal to the value of one, this means that the computer system 102 and/or the firmware 104 cannot support encrypted password protection within the firmware 104. Thus, the bit 202N denotes a potential incompatibility factor of the computer system 102 and/or the firmware 104 as to this attribute, because if a given firmware image requires the capability of the system 102 and/or the firmware 104 to support encrypted password protection, then the firmware 104 should not be upgraded with that firmware image.

The number of bits 202 within the first series 110 is desirably sufficiently large to denote any potential incompatibility factors of attributes of the computer system 102 and/or the firmware 104. The bits 202 are themselves independent of one another. That is, the setting of each of the bits 202 to either a value of zero or one does not necessarily depend on the setting of any other of the bits 202 to either a value of zero or one. Rather, each of the bits 202 is set based on whether the computer system 102 and/or the firmware 104 is compatible or incompatible with the attribute to which the bit corresponds.

Each of the bits 204 of the second series of bits 112 corresponds to one of the bits 202 of the first series of bits 110. Thus, the bit 204A corresponds to the bit 202A, the bit 204B corresponds to the bit 202B, the bit 204C corresponds to the bit 202C, the bit 204N corresponds to the bit 202N, and so on. That is, each of the bits 204 has a corresponding one of the bits 202 in that the bit of the second series 112 indicates whether the new firmware image 108 is compatible or not with the attribute to which the corresponding bit of the first series 110 corresponds.

For example, the bits 204A and 204B are equal to a value of one, which means that the new firmware image 108 is compatible with the particular types of graphics cards A and B to which the corresponding bits 202A and 202B correspond. Similarly, the bit 204C is equal to a value of zero, which means that the new firmware image 108 is incompatible with the particular type of graphic card C to which the corresponding bit 202C corresponds. In addition, the bit 204N is equal to a value of zero, which means that the new firmware image 108 requires (as opposed to not requiring) support of the encrypted password protection to which the corresponding bit 202N corresponds.

Thus, each of the bits 204 of the second series 112 is equal to a value of one when the firmware image 108 is compatible with the attribute to which the corresponding bit of the first series 110 corresponds, such that the firmware image 108 does not cause the potential incompatibility factor of the computer system 102 denoted by this bit of the first series 110 Otherwise, each of the bits 204 of the second series 112 can have a value of zero. For example, the bit 202A of the first series 110 having a value of one indicates that the computer system 102 and the firmware 104 requires that the firmware image 108 be compatible with the particular type of graphics card A. Because the corresponding bit 204A of the second series 110 also has a value of one, this means that the firmware image 108 is compatible with the particular type of graphics card A.

As another example, the bit 202N of the first series 110 having a value of one indicates that the computer system 102 and/or the firmware 104 requires that the firmware image 108 not require encrypted password protection. However, the corresponding bit 204A of the second series 110 has a value of zero, meaning that the firmware 108 requires encrypted password protection. Therefore, the firmware image 108 is not compatible with the computer system 102 and/or the firmware 104 in this regard. That is, the firmware image 108 causes the potential incompatibility factor of the attribute indicated by the bit 202N of the first series 110 having the value of one.

To determine whether the firmware 104 and the computer system 102 are compatible with the new firmware image 108 presented, the bits 202 of the first series 110 are logically AND'ed with the bits 204 of the second series 112, resulting in the bits 208 of the resulting series 206. For example, the bits 202A and 204A are logically AND'ed together, resulting in the bit 208A, and the bits 202B and 204B are logically AND'ed together, resulting in the bit 208B. Similarly, the bits 202C and 204C are logically AND'ed together, resulting in the bit 208C, and the bits 202N and 204N are logically AND'ed together, resulting in the bit 208N. In general, the value represented by the series of bits 110 is logically AND'ed with the value represented by the series of bits 112, resulting in the series of bits 206.

If the bits 202 of first series 110 as logically AND'ed with the bits 204 of the second series 112 equal the bits 202 of the first series 110, then this means that the computer system 102 is compatible with the new firmware image 108, and the firmware 104 of the system 102 may be updated or upgraded with the image 108. Thus, if any of the bits 202 of the first series 110 has a value of one, than a corresponding bit of the bits 204 of the second series 112 must also be equal to a value of one in order to allow the firmware 104 be upgraded with the firmware image 108. By comparison, if any of the bits 202 of the first series 110 has a value of zero, then a corresponding bit of the bits 204 of the second series 112 can have either a value of one or zero, and thus does not affect whether the firmware 104 can be upgraded with the firmware image 108.

For example, the bit 202A of the first series 110 having the value of one means that the computer system 102 requires that the firmware image 108 be compatible with a particular type of graphics card A. Because the corresponding bit 204A of the second series 110 also has the value of one, the firmware image 108 is compatible with this particular type of graphics card, and thus compatible with the system 102 in this respect. That is, the bit 202A logically AND'ed with the bit 204A results in the bit 208A, which has the same value as the bit 202A has.

By comparison, the bits 202B and 202C of the first series, corresponding to particular types of graphics cards A and B, have values of zero, meaning that the computer system 102 does not require that the firmware image 108 be compatible with either of these particular types of graphics cards A and B. Therefore, the fact that the firmware image 108 is compatible with the particular type of graphics card B, as represented by the bit 204B having the value of one, and is not compatible with the particular type of graphics card C, as represented by the bit 204C having the value of zero, does not affect the compatibility of the image 108 with the system 102. That is, the bits 202B and 202C logically AND'ed with the bits 204B and 204C results in the bits 208B and 208C, which have the same value as the bits 202B and 202C have.

As a final example, the bit 202N of the first series 110 having the value of one means that the computer system 102 requires that the firmware image 108 not require the system 102 and/or the firmware 104 to support encrypted password protection. However, the bit 204N of the second series 112 has a value of zero, meaning that the firmware image 108 does indeed require the system 102 and/or the firmware 104 to support encrypted password protection. Thus, the bit 202N logically AND'ed with the bit 204N results in the bit 208N, which has a different value than the bit 202N has. Therefore, the firmware image 108 is not compatible with the computer system 102 with respect to the attribute denoted by the bit 202N. That is, the bit 202N identifies a potential incompatibility factor of the system 102, where the firmware image 108 indeed causes this incompatibility factor.

Therefore, in general, if any of the bits 202 of the first series 110 logically AND'ed with the corresponding bit of the bits 204 of the second series 112 does not result in the bit of the bits 202, then the computer system 102 is not compatible with the firmware image 108. Put another way, if the value represented by the bits 202 logically AND'ed with the value represented by the bits 204 does not equal the value represented by the bits 202, then the computer system 102 is not compatible with the firmware image 108. If any of the bits 202 of the first series 110 has a value of one, indicating a potential incompatibility factor for a given attribute of the computer system 102 and/or the firmware 104, then the corresponding bit of the bits 204 of the second series 112 must also have a value of one for the firmware image 108 to be compatible with the system 102. Otherwise, the firmware image 108 causes the potential incompatibility factor in question, and therefore the image 108 is not loaded into the firmware 104.

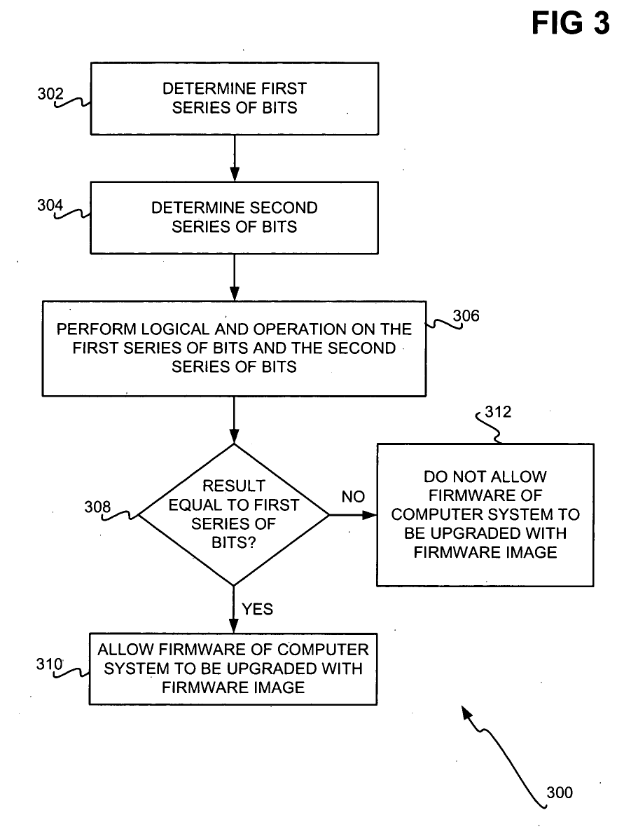

FIG. 3 shows a method 300 for determining whether to upgrade the firmware 104 of the computer system 102 with the new firmware image 108, according to an embodiment of the invention. The method 300 may be implemented in one embodiment as one or more computer program parts executable by a processor of a computer, such as by the firmware upgrade computer program 106 of FIG. 1. The method 300 first determines the first series of bits 110 (302). For instance, the first series of bits 110 may be retrieved from the computer system 102. The method 300 next determines the second series of bits 112 (304). Similarly, the second series of bits 112 may be retrieved from the firmware image 108.

The method 300 then performs a logical AND operation on the first series of bits 110 and the second series of bits 112 (306), as has been described. For example, performing this logical AND operation results in the series of bits 206 in the example depicted in and described in relation to FIG. 2. If the result of the logical AND operation is equal to the first series of bits 110 (308), then the firmware 104 of the computer system 102 is allowed to be upgraded with the firmware image 108 (310). Otherwise, the firmware 104 is not allowed to be upgraded with the firmware image 108 (312).

Thus, if the result of the logical AND operation is equal to the first series of bits 110, then this means that the new firmware image 108 is compatible with the computer system 102 and the firmware 104. Therefore, the firmware 104 may be updated or upgraded with the firmware image 108 by loading of the image 108 onto or into the firmware 104, such as by the firmware upgrade program 106. However, if the result of the logical AND operation is not equal to the first series of bits 110, then this means that the new firmware image 108 is not compatible with the system 102 and the firmware 104.

It is noted that after the upgrading of the firmware 104 with the firmware image 108, the firmware 104 still maintains the same associated series of firmware-related bits 110. That is, the firmware-related series of bits 110 is particular to a given computer system 102 and/or firmware 104. Therefore, the series of bits 110 does not change when a new firmware image 108, having an associated series of firmware-related bits 112, is loaded into the firmware 104. Furthermore, the entity that performs the method 300, such as the firmware upgrade computer program 106 does not have to know the significance of any of the bits of the first series 110 or the second series 112, and does not have to know the origin of these bits. Rather, the entity only has to perform the method 300 to determine whether to allow the firmware 104 to be updated with the new firmware image 108.

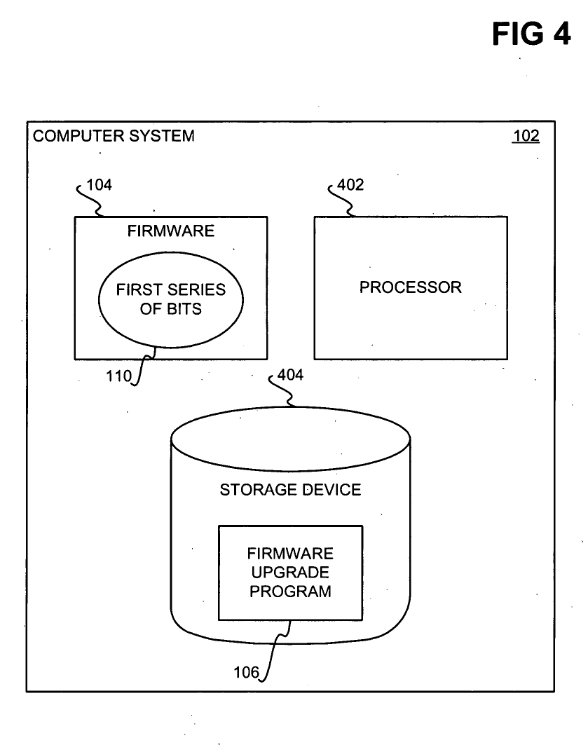

FIG. 4 shows the computer system 102 in more detail, according to a specific embodiment of the invention. The system 102 is depicted as including the firmware 104, a processor 402, and the storage device 404 storing the firmware upgrade computer program 106. As can be appreciated by those of ordinary skill within the art, the computer system 102 may have other components, in addition to and/or in lieu of those depicted in FIG. 4, in other embodiments of the invention.

The firmware 104 is specifically depicted in FIG. 4 as storing the first series of firmware-related bits 110, whereas the storage device 404 is specifically depicted in FIG. 4 as storing the firmware upgrade computer program 106. The storage device 404 may be or include non-volatile storage, such as hard disk drives, as well as volatile storage, such as semiconductor memories. The processor 402 executes the upgrade program 106 from the storage device 404 in one embodiment to determine whether to upgrade the firmware 104 with a new firmware image, based on the first series of bits 110 associated with the system 102 being compared with a second series of bits associated with the new firmware image. The upgrade program 106 also actually upgrades the firmware 104 with the new firmware image when the new firmware image is compatible with the computer system 102 and the firmware 104.

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. For instance, whereas different of the bits 202 have been described as relating to particular attributes of the computer system 102 and/or of the firmware 104 thereof, regarding particular potential incompatibility factors in relation to these attributes, such particular attributes and particular potential incompatibility factors have been presented for example purposes only. Other embodiments of the invention can have bits relating to different attributes, and thus different potential incompatibility factors, as can be appreciated by those of ordinary skill within the art. Therefore, it is manifestly intended that this invention be limited only by the claims and equivalents thereof.

We claim:

1. A method comprising:
determining a first series of firmware-related bits, the first series of bits corresponding to firmware compatibility information of firmware of a computer system, each bit of the first series corresponding to an attribute of at least one of the computer system and the firmware;
determining a second series of firmware-related bits, the second series of bits corresponding to a firmware image with which the firmware of the computer system is desired to be upgraded, each bit of the second series indicating whether the firmware image is compatible with the attribute of a corresponding bit of the first series;
performing a logical AND operation on the first series of bits and the second series of bits;
where a result of the logical AND operation is equal to the first series of bits, allowing the firmware of the computer system to be upgraded with the firmware image; and,
where the result of the logical AND operation is unequal to the first series of bits, disallowing the firmware of the computer system from being upgraded with the firmware image.

2. The method of claim 1, wherein each bit of the first series is equal to a value of one where the attribute to which the bit corresponds denotes a potential incompatibility factor of the computer system as to the attribute, such that a corresponding bit of the second series corresponding to the firmware image must also be equal to a value of one in order to allow the firmware of the computer system to be upgraded with the firmware image.

3. The method of claim 2, wherein each bit of the first series is equal to a value of zero where the attribute to which the bit corresponds does not denote a potential incompatibility factor of the computer system as to the attribute, such that a corresponding bit of the second series corresponding to the firmware image can have any value and does not affect whether the firmware of the computer system is allowed to be upgraded with the firmware image.

4. The method of claim 2, wherein each bit of the second series is equal to a value of one where the firmware image is compatible with the attribute corresponding to the bit of the first series to which the bit of the second series corresponds, such that the firmware image does not cause the potential incompatibility factor of the computer system denoted by the bit of the first series.

5. The method of claim 4, wherein each bit of the second series is otherwise equal to a value of zero.

6. The method of claim 1, wherein determining the first series of firmware-related bits comprises retrieving the first series of bits from the computer system.

7. The method of claim 1, wherein determining the first series of firmware-related bits comprises retrieving the second series of bits from the firmware image.

8. A computer system comprising:
a firmware, the firmware having an associated first series of bits corresponding to compatibility information of the firmware, each bit of the first series corresponding to an attribute of at least one of the computer system and the firmware; and,
a storage device receptive to storage of a computer program executed by the computer system to upgrade the firmware of the computer system based on at least the first series of bits associated with the firmware.

9. The computer system of claim 8, wherein the computer program is to upgrade the firmware of the computer system with a firmware image having an associated second series of bits, each bit of the second series indicating whether the firmware image is compatible with the attribute of a corresponding bit of the first series, the computer program to upgrade the firmware of the computer system with the firmware,image based on the first series of bits associated with the firmware and the second series of bits associated with the firmware image.

10. The computer system of claim 9, wherein the computer program is to perform a logical AND operation on the first series of bits and the second series of bits, such that where a result of the logical AND operation is equal to the first series of bits, the computer program upgrades the firmware with the firmware image, and where the result of the logical AND operation is unequal to the first series of bits, the computer program does not upgrade the firmware with the firmware image.

11. The computer system of claim 9, wherein each bit of the first series is equal to a value of one where the attribute to which the bit corresponds denotes a potential incompatibility factor of the computer system as to the attribute, such that a corresponding bit of the second series corresponding to the firmware image must also be equal to a value of one in order to allow the firmware of the computer system to be upgraded with the firmware image.

12. The computer system of claim 11, wherein each bit of the first series is equal to a value of zero where the attribute to which the bit corresponds does not denote a potential incompatibility factor of the computer system as to the attribute, such that a corresponding bit of the second series corresponding to the firmware image can have any value and does not affect whether the firmware of the computer system is allowed to be upgraded with the firmware image.

13. The computer system of claim 11, wherein each bit of the second series is equal to a value of one where the firmware image is compatible with the attribute corresponding to the bit of the first series to which the bit of the second series corresponds, such that the firmware image does not cause the potential incompatibility factor of the computer system denoted by the bit of the first series.

14. The computer system of claim 13, wherein each bit of the second series is otherwise equal to a value of zero.

15. An article of manufacture comprising:
a computer-readable medium; and,
means in the medium for upgrading a firmware of a computer system with a firmware image based on comparing a first series of bits associated with the firmware with a second series of bits associated with the firmware image,
each bit of the first series corresponding to an attribute of at least one of the computer system and the firmware, and
each bit of the second series indicating whether the firmware image is compatible with the attribute of a corresponding bit of the first series.

16. The article of manufacture of claim 15, wherein the means is further for performing a logical AND operation on the first series of bits and the second series of bits, such that where a result of the logical AND operation is equal to the first series of bits, the means upgrades the firmware with the firmware image, and such that where the result of the logical AND operation is unequal to the first series of bits, the means does not upgrade the firmware with the firmware image.

17. The article of manufacture of claim 15, wherein each bit of the first series is equal to a value of one where the attribute to which the bit corresponds denotes a potential incompatibility factor of the computer system as to the attribute, such that a corresponding bit of the second series corresponding to the firmware image must also be equal to a value of one in order to allow the firmware of the computer system to be upgraded with the firmware image,
and wherein each bit of the first series is equal to a value of zero where the attribute to which the bit corresponds does not denote a potential incompatibility factor of the computer system as to the attribute, such that a corresponding bit of the second series corresponding to the firmware image can have any value and does not affect whether the firmware of the computer system is allowed to be upgraded with the firmware image.

18. The article of manufacture of claim 17, wherein each bit of the second series is equal to a value of one where the firmware image is compatible with the attribute corresponding to the bit of the first series to which the bit of the second series corresponds, such that the firmware image does not cause the potential incompatibility factor of the computer system denoted by the bit of the first series.

19. The article of manufacture of claim 18, wherein each bit of the second series is otherwise equal to a value of zero.

20. The article of manufacture of claim 15, wherein the means is further for storing the firmware image and the second series of bits.
